(19) United States
(12) Patent Application Publication
(10) Pub. No.: US 2010/0283244 A1
(43) Pub. Date: Nov. 11, 2010

(54) Energy Generation and Storage System

(75) Inventors: Brian Howson, Peoria, IL (US); Kevin L. Martin, Washburn, IL (US); Daniel L. Mikrut, Geneva, IL (US)

Correspondence Address: Caterpillar Inc.;Intellectual Property Dept., AH 9510, 100 N.E. Adams Street, PEORIA, IL, 61629-9510, US

(73) Assignee: Caterpillar Inc., Peoria, IL (US)

(21) Appl. No.: 12/463,541

(22) Filed: May 11, 2009

(51) Int. Cl. F03D 9/02

(52) U.S. Cl. 290/44

(57) ABSTRACT

A power generation and storage apparatus and method is provided. The apparatus includes a power generation assembly and an energy storage assembly operably coupled to the power generation assembly. The energy storage assembly includes a buoyant device and is configured to store energy by lowering the buoyant device to a lower depth of water, and to release energy by allowing the buoyant device to rise to a higher depth of water.

### TECHNICAL FIELD

This disclosure relates generally to a power generation system. In particular, the disclosure relates to an energy system utilizing buoyant forces from a body of water to store energy, such as from wind energy.

### BACKGROUND

World energy demand is growing, particularly for energy sources that are renewable and emit less carbon into the atmosphere. Consequently, wind energy captured through the use of wind turbines is rapidly expanding as one available means to fulfill energy demand. Moreover, wind turbines are increasingly located in bodies of water (“off-shore”). Locating a wind turbine off-shore may use favorable winds that can occur over a body of water. In addition, land constraints and other factors, such as aesthetic concerns and government regulation, may make it advantageous to locate a wind turbine off-shore instead of on land.

However, despite considerable recent advances in wind energy technology, wind energy still has certain drawbacks. First, because the wind is intermittent, the energy produced by a wind turbine may be variable and uncertain. Second, demand for energy is also variable. If there is insufficient demand for the energy produced by a wind turbine at any particular moment in time, then the energy produced by that turbine from available wind forces is lost. Means exist to store excess energy, such as batteries; however there is transmission loss in power lines from off-shore turbines to energy storage devices, as well as increased cost.

Various systems have attempted to take advantage of the placement of a wind turbine in a body of water. For example, U.S. Pat. No. 4,266,403 to Hirbod (“Hirbod”) discloses an apparatus to harvest both wind and wave energy. Specifically, Hirbod discloses an apparatus with a first housing held at a fixed height above the bottom of a body of water and having an internal cavity, and a buoyant second housing having an internal cavity surrounded by sleeves. The walls of the internal cavity of the first housing are slidably contained for allowing relative movement between the first and second housings in response to wave action. However, Hirbod does not disclose an energy storage system for harvesting energy for later use. Prior art devices such as those disclosed in Hirbod do not overcome intermittency problems of wind energy discussed above.

The present disclosure is directed to overcoming or mitigating one or more of the problems set forth above.

### SUMMARY

In one aspect of the disclosure, an energy generation and storage apparatus is provided. The apparatus has a power generation assembly and an energy storage assembly operably coupled to the generator assembly. The energy storage assembly has at least one buoyant device, and is configured to store energy by lowering the buoyant device to a lower depth of water. The energy storage assembly is also configured to release energy by allowing the buoyant device to rise to a higher depth of water.

In another aspect of the disclosure, a method of storing power is disclosed. The method includes the step of lowering a buoyant device to a first depth of water. The method also includes the step of permitting the buoyant device to rise to a second depth of water; and the further step of converting the buoyant force acting on the buoyant device into electricity as the buoyant device rises to the second depth of water.

In another embodiment of the disclosure, an energy storage apparatus is disclosed. The energy storage apparatus includes a power generation assembly and an energy storage assembly operably coupled to the power generation assembly. The energy storage assembly has a buoyant device, a cable, a pulley, and a spool. The energy storage assembly stores energy by lowering the buoyant device to a lower depth of water and releases energy by allowing the buoyant device to rise to a higher depth of water.

### BRIEF DESCRIPTION OF THE DRAWINGS

FIG. 1 is a diagrammatic illustration of a power system according to one embodiment of the present disclosure.

FIG. 2 is a diagrammatic illustration of a power system according to a second embodiment of the present disclosure.

FIG. 3 is a diagrammatic illustration of a power generator system according to an embodiment of the present disclosure.

### DETAILED DESCRIPTION

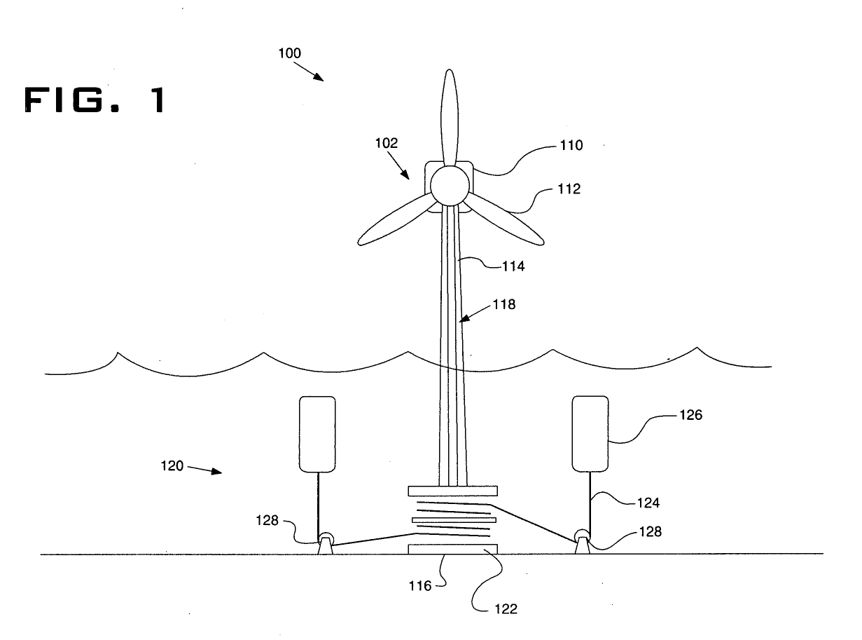

FIG. 1 shows a power system 100 for generating and storing energy (e.g., electricity). The power system 100 includes a power generation assembly 102 and an energy storage assembly 120. The power generation assembly 102 includes a generator 110 attached to a plurality of blades 112 and to a turbine support 114. Turbine support 114 is attached to the surface of the sea floor at a base 116. As shown, turbine support 114 is partially submerged and extends above the surface of the water to allow blades 112 to rotate according to wind forces. Power generation assemblies for wind turbines, including those suitable for use off-shore, are well known in the art and are appropriate for use with one or more embodiments described herein.

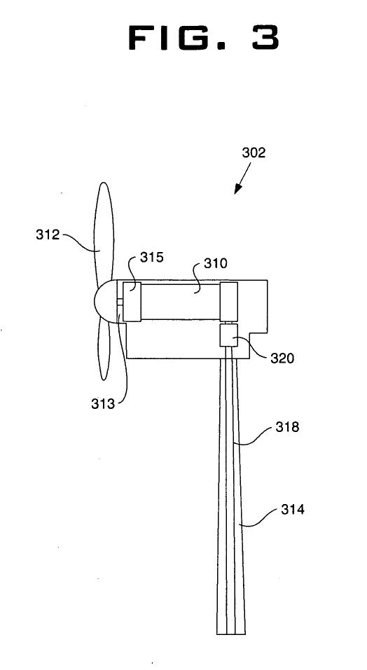

As shown in FIG. 1, turbine support 114 may be hollow, and may contain a mechanical shaft 118 extending substantially through the length of turbine support 114. Mechanical shaft 118 is able to rotate about an axis centered on its diameter, and is operably attached to generator 110 by means of power generation assembly (FIG. 3). This attachment allows mechanical shaft 118 to rotate as blades 112 rotate in response to wind force, but also allows mechanical shaft 118 to disengage from generator 110, so that at times (detailed below) blades 112 may rotate but mechanical shaft 118 does not.

Power system 100 also includes energy storage assembly 120, which, in the embodiment shown in FIG. 1, includes mechanical shaft 118 operably attached to a spool 122. A gear assembly or similar mechanism (FIG. 3) allows spool 122 to rotate as mechanical shaft 118 rotates. Spool 122 contains a length of one or more cables 124 which attach to buoyant devices 126.

Each buoyant device 126 in energy storage assembly 120 may include a pressure vessel or any suitable structure that exerts an upward force on cables 124. For example, buoyant device 126 might be constructed of a hollow container that would float on water when subjected to no other artificial forces. Buoyant device 126 need not be hollow, however. A structure is suitable as long as a buoyant force is created by a pressure difference between water at the top and bottom of the buoyant device 126.

Pulleys 128 attached to the sea floor act to ensure that the force transmitted on buoyant devices 126 from cables 124 is mostly or entirely in a plane perpendicular to the surface of the water. As used herein, a “higher” depth of water means a depth of water closer to the surface of the water, and a “lower” depth of water means a depth of farther below the surface of the water.

It should be noted that embodiments according to the present disclosure are sufficiently adaptable to a variety of situations. Power system 100 may be located in any body of water suitable for common wind turbines, such as a lake or ocean. Moreover, any number and size of buoyant devices 126 may be used.

Further, although in the embodiment of FIG. 1, buoyant devices 126 are located near turbine support 114, buoyant devices 126 may be located farther away from turbine support 114 if conditions warrant. One method of locating buoyant devices 126 away from turbine support 114 is to increase the distance between pulleys 128 and buoyant devices 126.

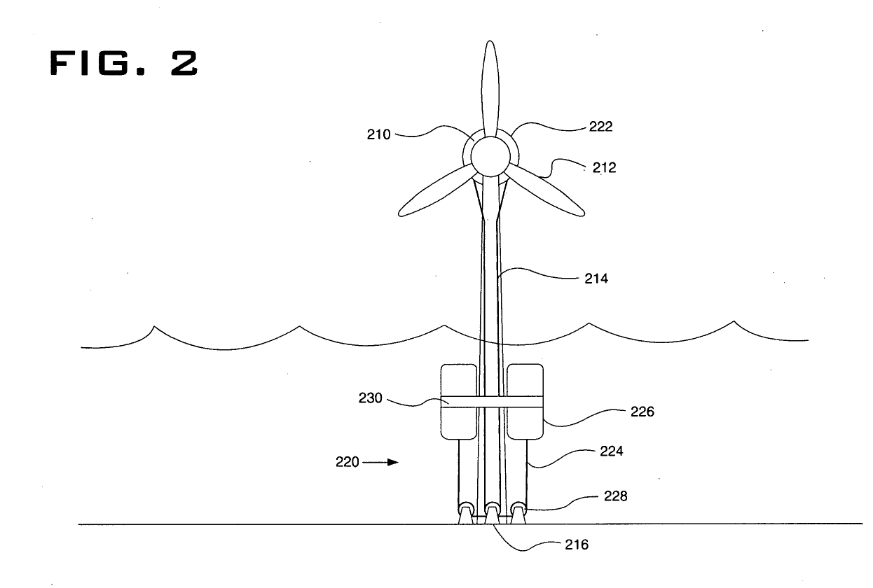

FIG. 2 shows another embodiment according to the present disclosure. In this configuration, a power system 200 has a power generation assembly 202 and an energy storage assembly 220. Power generation assembly 202 includes a generator 210 and blades 212. Power generation assembly 202 is mounted on a turbine support 214 that extends partially underwater and is anchored at base 216.

In this embodiment, energy storage assembly 220 includes a spool 222 mounted above water about turbine support 214. Spool 222 may rotate as blades 212 turn from wind forces, or spool 222 may be disengaged from rotating with blades 212 by using known means such as a clutch. Cables 224 wrap around spool 222 and connect to buoyant devices 226 via one or more pulleys 228 near base 216 at the sea floor.

In this embodiment, an attachment member 230 connects buoyant devices 226, which acts to at least partially constrain the lateral range of motion of each buoyant device 226. In this configuration, multiple buoyant devices 226 may be affixed at or near turbine support 214 in an annular fashion around the diameter of turbine support 214. This may be helpful if it is necessary to constrain the lateral movement of buoyant devices 226.

FIG. 3 shows a power generation assembly 302 according to an embodiment of the present disclosure. A plurality of blades 312 are attached to a drive shaft 313 and extend radially from the portion of power generation assembly 302 containing the drive shaft 313. Drive shaft 313 optionally connects to a gearbox 315. Gearbox 315 provides optimal rotational speed for a generator 310. Generator 310 can be any known generator set in the art for transforming rotational energy of drive shaft 313 into electrical energy. Drive shaft 313 is also operably attached to gearbox 320, which can provide direction selection for the rotation of mechanical shaft 318, which selects whether flotation devices (not shown in FIG. 3) will be raised or lowered, and braking, when necessary to prevent unwanted rotation of mechanical shaft 318. Mechanical shaft 318 may be housed, as shown, in turbine support 314.

### INDUSTRIAL APPLICABILITY

The present disclosure provides an advantageous apparatus and method to efficiently produce and store energy from wind power. In operation, and returning to FIG. 1 by way of example, the energy storage assembly 120 may be selectively engaged to store energy and release energy at a desired time. To store energy, at least a portion of wind force acting on blades 112 is transmitted to rotate mechanical shaft 118, thereby turning spool 122 and lowering buoyant devices 126 to a lower depth of water. To release energy, buoyant devices 126 are allowed to rise to a higher depth of water, causing mechanical shaft 118 to rotate while operably connected to generator 110, thereby generating power.

Various control parameters may be utilized to optimally control operation of power system 100. For example, a remote signal may be sent to power system 100 to engage the energy storage assembly 120, and thereby divert at least a portion of the wind force energy to lower the buoyant devices 126 when there is insufficient demand from external sources for the energy produced by power system 100. Therefore, one control parameter may be immediate energy demand. Another potential control parameter may be the spot price of electricity in the energy markets. If the current spot price falls below a specified threshold, the energy storage assembly 120 may be engaged to store energy for release when the price exceeds a threshold amount. Power system 100 may be used, therefore, to generate power during off-peak hours for storage and later release during peak energy demand times.

Alternatively, and still referring to FIG. 1 as an example, power system 100 may be configured to automatically store energy whenever it is mechanically possible to lower one or more buoyant devices 126 to a lower depth of water, and then to release energy when the available wind force falls below a certain threshold. This configuration allows power system 100 to provide at least some power during times when there is insufficient available wind for the power generation assembly.

Additionally, it can be seen that the total energy storage capacity of the power system 100 is smaller in shallower water. However, the overall energy storage capacity of the system may be increased by increasing the number of buoyant devices 126 in the system and/or by increasing the volume of each buoyant device 126, thereby increasing the total buoyant force exerted when the buoyant devices 126 are allowed to rise towards the surface of the water. In this fashion, multiple buoyant devices 126 could be attached in series and/or in parallel along each cable 124 to increase the total volume of water displaced, and thereby increase the total amount of energy storage capacity in energy storage assembly 120.

In addition, buoyant devices 126 need not be raised completely to the surface of the water, nor be lowered entirely to the sea floor, if the location of power system 100 does not permit it due to terrain, weather conditions, or other factors. The overall length of cables 124 may be adjusted to permit the desired range of motion of buoyant devices 126.

Other embodiments, features, aspects, and principles of the disclosed examples will be apparent to those skilled in the art and may be implemented in various environments and systems.

### LIST OF ELEMENTS

100 power system
102 power generation assembly
110 generator
112 blade
114 turbine support
116 base
118 mechanical shaft
120 energy storage assembly
122 spool
124 cable
126 buoyant device
128 pulley
200 power system
202 power generation assembly
210 generator
212 blade
214 turbine support
216 base
218 mechanical shaft
220 energy storage assembly
222 spool
224 cable
226 buoyant device
228 pulley
230 attachment member
302 power generation assembly
312 blade
313 turbine shaft
314 turbine support
315 gearbox
318 mechanical shaft
320 gearbox

What is claimed is:

1. An energy storage apparatus comprising:
a power generation assembly; and
an energy storage assembly operably coupled to the power generation assembly and including a buoyant device, the energy storage assembly configured to store energy by lowering the buoyant device to a lower depth of water and configured to release energy by allowing the buoyant device to rise to a higher depth of water.

2. The apparatus of claim 1, wherein the power generation assembly includes a drive shaft for generating electrical power and a blade extending radially from a portion of the power generation assembly containing the drive shaft.

3. The apparatus of claim 1, wherein the energy storage assembly includes a plurality of buoyant devices.

4. The apparatus of claim 3, including an attachment member to at least partially constrain motion of the plurality of buoyant devices.

5. The apparatus of claim 1, wherein the buoyant device is a pressure vessel.

6. The apparatus of claim 1, including a control system to store and release energy from the energy storage assembly according to a control parameter.

7. The apparatus of claim 6, wherein the control parameter includes energy demand from an external source.

8. The apparatus of claim 6, wherein the control parameter includes available wind force.

9. The apparatus of claim 6, wherein the control parameter includes spot price of electricity.

10. A method of storing and releasing energy, comprising:
lowering a buoyant device to a first depth of water;
permitting the buoyant device to rise to a second depth of water; and
converting a buoyant force acting on the buoyant device into electricity as the buoyant device rises to the second depth of water.

11. The method of claim 10, including the step of providing a control parameter to initiate the step of converting a buoyant force acting on the buoyant device into electricity.

12. The method of claim 11, wherein the control parameter includes energy demand from an external source.

13. The method of claim 11, wherein the control parameter includes available wind force.

14. The method of claim 11, wherein the control parameter includes spot price of electricity.

15. An energy storage apparatus comprising:
a power generation assembly; and
an energy storage assembly operably coupled to the power generation assembly and including a buoyant device, a cable, a pulley, and a spool;
wherein the energy storage assembly is configured to store energy by lowering the buoyant device to a lower depth of water and releases energy by allowing the buoyant device to rise to a higher depth of water.

16. The energy storage apparatus of claim 15, wherein the buoyant device is a pressure vessel.

17. The energy storage apparatus of claim 15, including a control system to selectively store and release energy from the energy storage assembly according to a control parameter.

18. The energy storage apparatus of claim 17, wherein the energy storage assembly includes a plurality of buoyant devices.

19. The energy storage apparatus 18, including an attachment member to at least partially constrain motion of the plurality of buoyant devices.

20. The energy storage apparatus of claim 17, wherein the control parameter includes spot price of electricity.
